(19) United States
(12) Patent Application Publication
(10) Pub. No.: US 2015/0314624 A1
(43) Pub. Date: Nov. 5, 2015

(54) PRINTER COVER OPENING METHOD AND MECHANISM

(71) Applicant: TOSHIBA GLOBAL COMMERCE SOLUTIONS HOLDINGS CORPORATION, Tokyo (JP)

(72) Inventor: Richard Hunter Harris, Raleigh, NC (US)

(73) Assignee: TOSHIBA GLOBAL COMMERCE SOLUTIONS HOLDINGS CORPORATION, Tokyo (JP)

(21) Appl. No.: 14/265,926

(22) Filed: Apr. 30, 2014

(51) Int. Cl. B41J 29/54

(52) U.S. Cl. CPC B41J 29/54

(57) ABSTRACT

A printer that may be part of a point of sales terminal. The printer includes a latching mechanism that helps hold the printer's cover in the closed position when latched, but allows the cover to open when unlatched. The latching mechanism is automatically moved to an unlatched state by reversing the paper feed motor. Related methods of operating a printer are also disclosed.

### BACKGROUND

This application is related to printers, such as for point of sale terminals.

Many point of sale terminals include printers to print out receipts. These printers are, in many cases, thermal printers that require appropriate paper to print on. This paper is typically supplied in the form of a paper roll, with the paper fed from the roll to a printhead of the printer for printing on, and then out the printer. Such printers typically include a driven print platen roller disposed opposite the printhead that acts both as a backing surface for the paper while it is being printed on, and as a means of feeding the paper. Because the printer includes various moving and/or sensitive parts, the printer mechanisms are typically hidden from view/interference in a suitable housing. Due to the requirement for replacing the paper when it runs out and/or attending to printer malfunctions, the housing typically includes a cover that may be pivoted open to access the paper supply area and the printer mechanism. Such covers are normally held closed, but openable by manually pressing a button or other release on the cover.

While such printers are suitable for many applications, they are not ideal for all situations. For example, it may be desirable for the printer cover to automatically open when a printer error is detected, or the paper supply has run out, so as to readily signal to the user of the point of sale terminal that attention is needed. Likewise, it may be desirable for the covers to automatically open when the paper supply is low at particular times, such as at a shift change, so induce appropriate action to be taken.

As such, there remains a need for alternative printer designs, particularly printer designs that allow for the printer's cover to be automatically opened in appropriate situations, without adding significantly to the complexity of the printer and any associated point of sale terminal.

### SUMMARY

The present invention provides a printer, such as a printer for a point of sale terminal, that includes a latching mechanism that helps hold the printer's cover in the closed position when latched. The latching mechanism is automatically moved to an unlatched state by reversing the paper feed motor. The present invention also provides related methods of operating a printer.

In one embodiment, a includes a base housing; a paper supply cavity; a cover, a printhead, a platen roller, and a latch. The cover is moveably mounted to the base housing for movement between a closed position where the cover helps enclose the paper supply cavity and at least one open position where the paper supply cavity is accessible. The printhead is movably associated with one of the base housing and the cover. The platen roller is rotatably mounted to the other of the base housing and the cover for rotation about a platen axis in a forward feed direction and a reverse direction. The drive motor is operatively coupled to the platen roller to drive the platen roller to rotate. The latch is movable between a latching position, where the latch connects the base housing to the cover such that the cover is latched in the closed position, and a release position where the latch is displaced relative to the latching position so as to allow movement of the cover toward the open position. With the cover in the closed position: a) the printhead and platen roller are positioned relatively closer to each other for printing on paper therebetween; and b) rotation of the platen roller in the reverse direction urges the latch toward the release position. With the cover in the open position, the printhead and platen roller are positioned relatively farther from each other so as to be positioned unsuitably for printing on paper therebetween.

In some embodiments the printhead is movably associated with the cover and the drive platen is associated with the base housing. In some embodiments, this relationship is reversed. The cover may be pivotally mounted to the base housing and/or may advantageously be biased toward the open position. The base housing may comprises the paper supply cavity. With the cover in the closed position, rotation of the platen roller in the forward feed direction urges the latch toward the latching position in some embodiments. The latch may comprise a latch frame pivotally mounted to the cover. The printer may further comprise a processing circuit disposed within the base housing and operative to control rotation of the drive motor. The printer may further comprise an externally accessible actuator that extends through the cover. The actuator may be in operative communication with the processing circuit. The processing circuit may be configured to respond to actuation of the actuator by causing the drive motor to assume a reverse operation that drives the drive platen in the reverse direction, to thereby urge the latch toward the release position. The actuator may be disposed so that movement of the actuator mechanically engages the actuator to the latch and urges the latch toward the release position.

In another embodiment, a method of controlling a printer comprises rotating a drive motor in a forward direction, and, as a result driving a platen roller to rotate forwardly to latch a base housing of the printer to a cover of the printer such that the cover is latched in a closed position wherein the cover helps enclose a paper supply cavity of the printer. The method includes thereafter rotating the drive motor in a reverse direction, and, as a result driving the platen roller to rotate reversedly to automatically unlatch the cover from the base housing to thereby allow the cover to move to an open position.

In some embodiments, rotating the drive motor in the reverse direction may be in response to detection of a printer error by a controller local to the printer. The rotating the drive motor in the reverse direction may additionally or alternatively be in response to receipt, by a controller local to the printer, of a command received from a controller remote from the printer. The method may advantageously be such that driving the platen roller to rotate reversedly comprises driving the platen roller to rotate reversedly so as to move a latch, distinct from the platen roller, to an unlatching position to thereby allow the cover to move to an open position. The method may further include, after the rotating the drive motor in the reverse direction: a) adding a paper supply to the paper supply cavity while the cover is not latched to the base assembly; and b) thereafter, moving the cover to the closed position and automatically latching the cover to the base housing.

In another embodiment, a method of controlling a printer comprises rotating a drive motor in a forward direction, and, optionally as a result urging a latch toward a latching position by driving a platen roller to rotate forwardly; the latch, when in the latching position, connecting a base housing of the printer to a cover of the printer such that the cover is latched in a closed position wherein the cover helps enclose a paper supply cavity of the printer. The method includes thereafter rotating the drive motor in a reverse direction, and, as a result urging the latch toward a release position by driving the platen roller to rotate reversedly; the latch, in the release position, allowing the cover to move to an open position.

In some embodiments, rotating the drive motor in the reverse direction may be in response to detection of a printer error by a controller local to the printer. The rotating the drive motor in the reverse direction may additionally or alternatively be in response to receipt, by a controller local to the printer, of a command received from a controller remote from the printer. The method may further include, after the rotating the drive motor in the reverse direction: a) adding a paper supply to the paper supply cavity while the cover is not latched to the base assembly; and b) thereafter, moving the cover to the closed position and automatically latching the cover to the base housing via the latch. The latch may be biased toward the latching position and the urging the latch toward the release position may comprise urging the latch toward the release position against a corresponding bias. The cover may be biased toward the open position, and allowing the cover to move to the open position may comprise automatically moving the cover to the open position.

The various aspects discussed above may be used alone or in any combination. The various apparatus disclosed herein may operate according to any combination of various methods disclosed herein, and vice versa. Further, the present invention is not limited to the above features and advantages. Indeed, those skilled in the art will recognize additional features and advantages upon reading the following detailed description, and upon viewing the accompanying drawings.

### BRIEF DESCRIPTION OF THE DRAWINGS

FIG. 1 shows a point of sale terminal with printer according to one or more embodiments of the present invention.

FIG. 2 shows a perspective view of a printer according to one or more embodiments, with the cover in the closed position.

FIG. 3 shows a partially cutaway side view of printer of FIG. 2, with the cover in the closed position.

FIG. 4 shows a partially cutaway side view of printer of FIG. 2, with the platen roller being driven in reverse.

FIG. 5 shows a partially cutaway side view of printer of FIG. 2, with the cover in a first open position.

FIG. 6 shows a partially cutaway side view of printer of FIG. 2, with the cover in a second more open position.

FIG. 7 shows a schematic of the printer of FIG. 2.

FIG. 8 shows an exemplary flowchart of one or more methods of the present invention.

### DETAILED DESCRIPTION

The present application is directed to printer mechanism and/or method of operating the same. The printer will be explained in the context of the printer being a portion of a point of sale terminal, but such is not required. As explained further below, the printer includes a latching mechanism that helps hold the printer's cover in the closed position when latched. The latching mechanism is automatically moved to an unlatched state by reversing the paper feed motor.

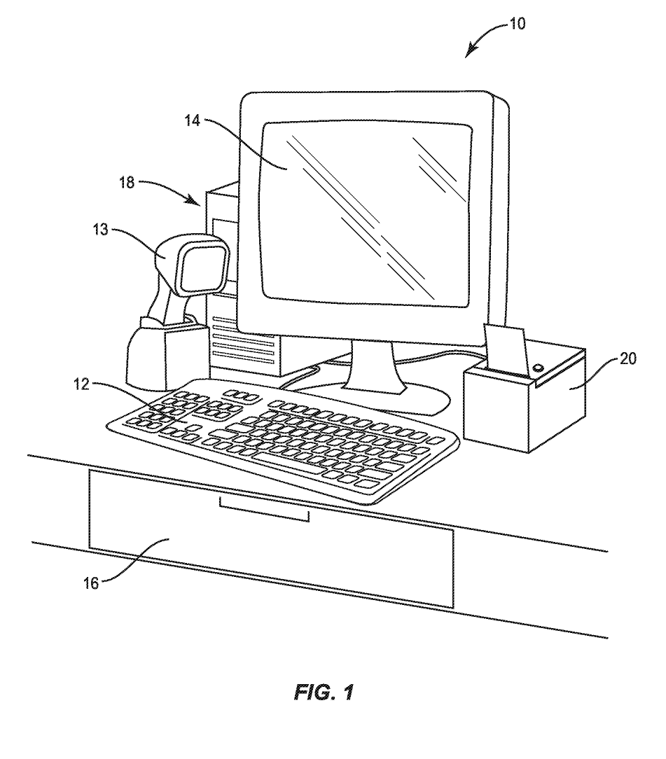

Referring to FIG. 1, a point of sale terminal is shown, generally indicated at 10. The point of sale terminal 10 includes a suitable keypad 12 and/or other entry means known in the art, a bar code scanner 13, one or more displays 14, an optional drawer 16, electronics 18, and a printer 20 according to one or more embodiments of the present invention. For the illustrated point of sale terminal 10, the printer 20 differs from a conventional printer, as explained further below. The keypad 12 is used for entry of information by a user. Bar code scanner 13 is used to identify items for entry into a sales transaction. The display(s) 14 are used to display relevant information. The drawer 16 may be used to safely store currency and other suitable items. The electronics 18 includes suitable control circuitry and typically one or more communications interfaces, such as for communicating with a store's network. Additional details of the general overall configuration and operations of the point of sale terminal 10 are known to those of skill in the art, and are not explained in detail here in order to avoid obscuring the present invention.

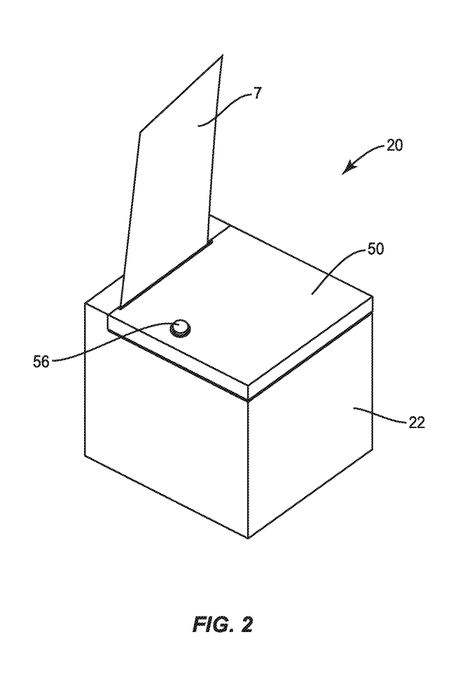

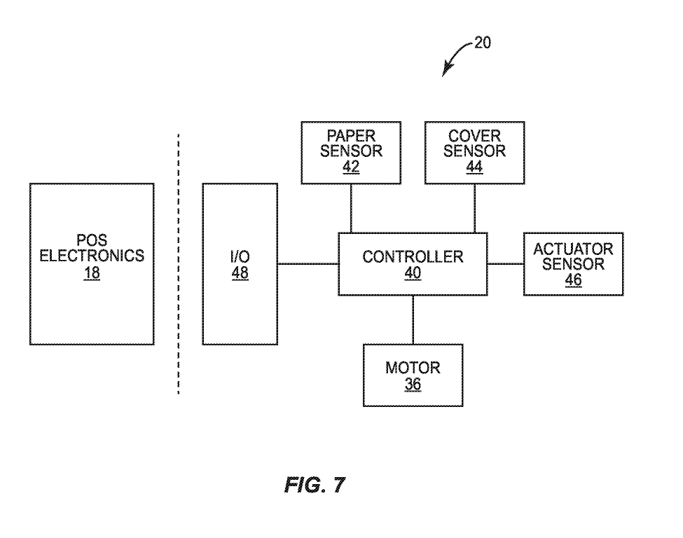

Referring to FIGS. 2-7, the printer 20 includes a base assembly 22 and a cover assembly 50. The base assembly 22 includes a base housing 24, a platen roller 30, a drive motor 36, a printer controller 40, and a communications interface 48. The base housing 24 may be a portion of the overall housing of the point of sale terminal 10, and/or may be a separate housing. The base housing 24 defines one or more cavities that house the main printer mechanism. One cavity formed by the base housing 24 is a paper supply cavity 26. The paper supply cavity is configured to receive the paper supply, such as paper roll 5, for supply to the printing area. Disposed adjacent the paper supply cavity 26 is the platen roller 30. The platen roller 30 is a generally cylindrically shaped roller having a suitable outer surface for acting as a backing for the paper 7 when the paper is being printed. As such, the platen roller 30 has an elastically deformable surface that tends to flatten out under the pressures encountered during normal printing operations. The platen roller 30 is mounted for rotational movement about a platen axis 32 and may rotate either in a forward feed direction F or in a reverse direction B. The drive motor 36 supplies rotational power to the platen roller 30, either directly, or through a suitable gear train. The drive motor 36 may rotate in a forward direction (corresponding to the platen roller 30 rotating in the forward feed direction) or in a reverse direction (corresponding to the platen roller 30 rotating in the reverse direction). The drive motor 36 may take any suitable form, such as a stepper motor. The drive motor 36 operates under the control of the printer controller 40, which may be one or more suitable processing circuits. The controller 40 controls the operation of the printer 20, and may be operatively connected to one or more sensors, such as paper level sensor 42, cover open sensor 44, actuator sensor 46, and the like. The controller 40 may communicate with the remainder of the point of sale terminal 10, and with additional communication and/or control entities (such as control entities in a store's network) via one or more suitable communication interfaces 48.

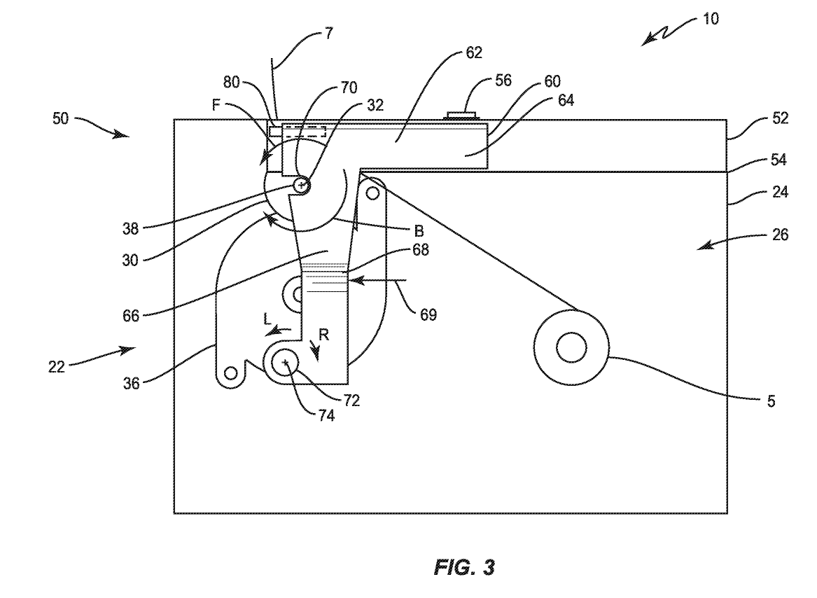

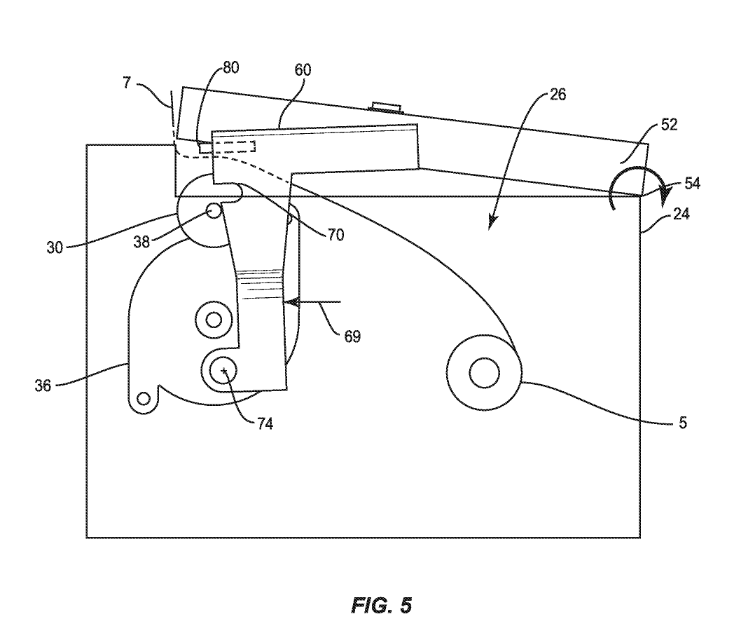

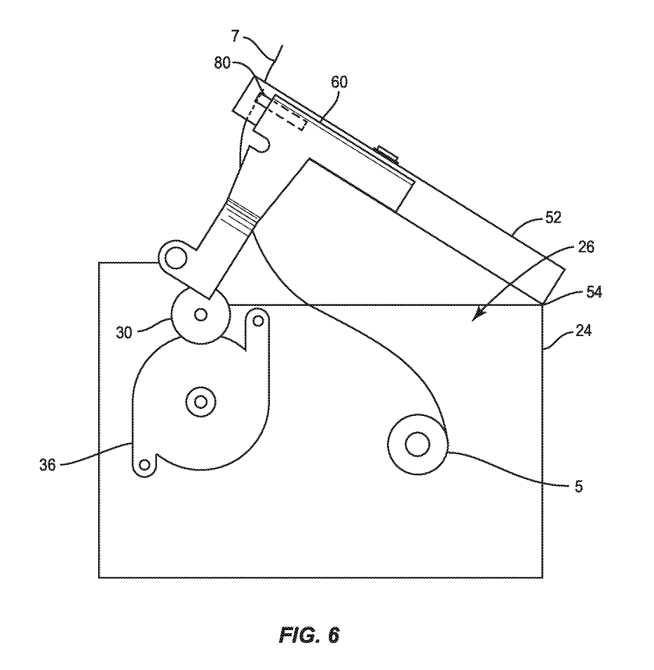

The cover assembly 50 is moveably mounted to the base assembly 22. The cover assembly 50 includes a cover 52 and a latch frame 60. The cover 52 is moveably mounted to the base housing 24, such as by being pivotally mounted to the base housing 24 at one or more hinges 54. In the illustrated embodiment, the hinge 54 is located toward the rear of the printer 20 and oriented parallel to the platen axis 32, so that the front of the cover 52 may be opened further than the rear of the cover 52. This is so that a suitably large opening may be formed between the cover 52 and the base housing 24 so that a paper supply roll 5 may be easily inserted into the paper supply cavity 26, and paper 7 may be fed to the platen roller 30 so as to facilitate reloading of paper 7. The cover 52 is movable between a closed position where the cover 52 helps enclose the paper supply cavity 26 (FIG. 3), and one or more open positions, where the cover 52 is pivoted away from the base housing 24 (e.g., FIGS. 5-6). The cover 52 may be advantageously biased open by one or more springs (not shown).

The latch frame 60 is pivotally mounted to the cover 52 for movement between a latching position (FIG. 3) and a release position (FIG. 5). The latch frame 60 includes a top section 62 and a side section 66. The top section 62 extends generally parallel to the platen axis 32, and serves as a location for mounting the printhead 80. The top section 62 may also include an actuator flange 64, as discussed further below. The side section 66 extends downward from the top section 62, and may include a stepped area 68 if needed for clearing other portions of the main printer mechanism. The side section 66 includes a notch 70. The notch 70 is configured to engage a catch 38 on the base assembly 22. For the illustrated embodiment, the catch 38 is a lateral extension of a mounting shaft for the platen roller 30. The latch frame 60 is pivotally mounted to the cover 52 for rotation about a latch pivot axis 74. The latch frame 60 may be mounted to one or more suitable flanges (not shown) that extend from the cover toward the base housing 24, so that pivot axis 74 extends through a corresponding opening 72 on latch frame 60 and though a boss (not shown) on the flange(s). Of course, the male-female relationship of these parts may be reversed, as is desired. With the cover 52 closed, rotating the latch frame 60 in a latching direction L causes the notch 70 to receive and/or retain the catch 38, so that the cover 52 is latched closed relative to the base assembly 22. Rotating the latch frame 60 in a release direction R causes the catch 38 to move out the notch 70, thereby releasing the cover 52 so that the cover 52 may move to an open position. The latch frame 60 is advantageously biased in the latching direction L by a suitable bias spring force 69, which is advantageously rather light in force.

The printhead 80 is mounted via a spring coupling to the underside of the latch frame 60. The printhead 80 may be any thermal printhead known in the art, or may be an ink jet printhead, or other type of printhead known in the art. The printhead 80 is positioned such that, when the cover 52 is in the closed position, the printhead 80 faces toward the platen roller 30. With paper 7 disposed between the printhead 80 and the platen roller 30, the printhead 80 advantageously presses downward onto the platen roller 30 so that the platen roller 30 is slightly deformed, as discussed above. The printhead 80 may connect to its controller 40 via a suitable flex-cable (not shown).

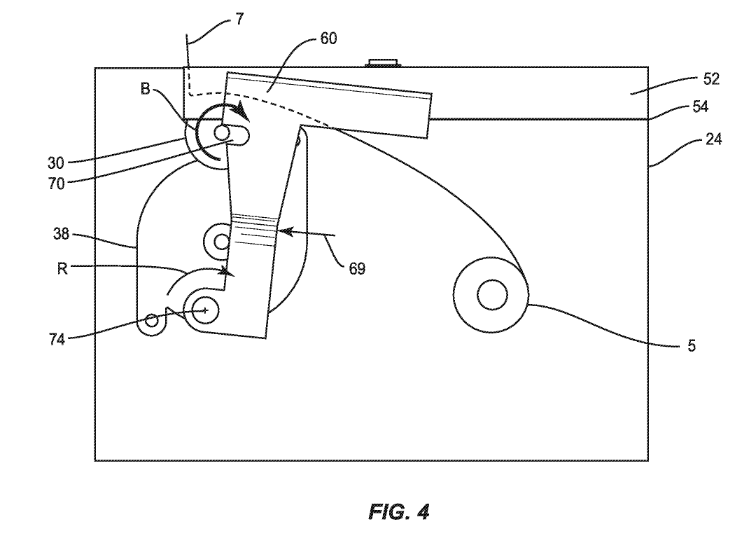

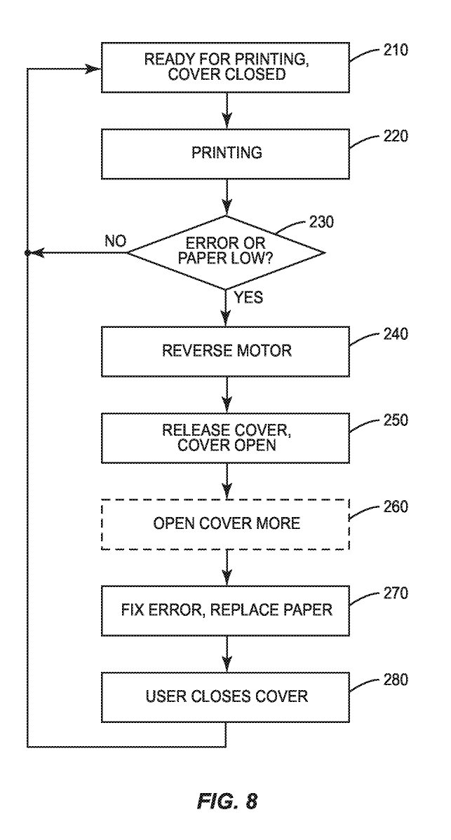

The automatic unlatching operations of the printer 20 are shown in flowchart form in FIG. 8. The process begins with a paper supply roll 5 present in the paper supply cavity 26, and paper 7 extending therefrom to the area between the printhead 80 and the platen roller 30, and then out the printer 20. With the cover 52 closed and latched, the printhead 80 and platen roller 30 are positioned for a printing operation (step 210). As the printing progresses (step 220), the platen roller 30 is rotated in the forward direction F by the drive motor 36. The frictional drag between the platen roller 30, the paper 7, and the printhead 80 applies a force to the printhead 80 that urges the latch frame 60 in the latching direction L. The printing operations continue until a printer error or low paper situation is detected (step 230), such as by controller 40 via paper level sensor 42. In response, and at an appropriate time, the controller 40 causes the drive motor 36 to drive the platen roller 30 in the reverse direction B (step 240). This reverse motion of the platen roller 30 causes, via the frictional drag between the platen roller 30, the paper 7, and the printhead 80, a force to be applied to the latch frame 60 that urges the latch frame 60 to rotate in the release position R. For example, the latch 60 is rotated in a clockwise direction in FIG. 4, which causes the notch 70 to move so that the notch 70 is no longer receiving the catch 38. With the latch 60 in the release position, the bias of the cover spring then automatically moves the cover 52 to the open position (step 250)(FIG. 5). If necessary, the user may then open the cover 52 more fully (step 260) (FIG. 6), or the cover spring may automatically move cover 52 to the full open position (FIG. 6).

The user then attends to the printer error, or replaces the paper supply roll 5 in the paper supply cavity 26 and feeds the “new” paper 7 between the printhead 80 and the platen roller 30 (step 270). Note that the cover 52 being in the open position separates the printhead 80 from the platen roller 30 by a relatively larger amount than when the cover 52 is in the closed position. Advantageously, the printhead 80 is moved far enough from the platen roller 30 that new paper may be easily loaded between the printhead 80 and the platen roller 30. The user then closes the cover 52 (step 280), which captures paper between the printhead 80 and the platen roller 30. Due to the bias force 69 on the latch frame 60, the latch frame 60 is positioned with the catch 38 disposed in the latching notch 70 as a result of the cover 52 being closed. The printer 20 is then ready for another printing operation.

In some embodiments, the printer 20 may also include an externally accessible actuator 56 that extends through the cover 52. The actuator 56 allows the user to manually trigger the movement of the latch 60 to the release position. For example, the actuator 56, when pressed, may mechanically bear against the actuator flange 64 of the latch frame 60, and thereby cause the latch 60 to rotate in the release direction R. Additionally or alternatively, movement of the actuator 56 may be detected by sensor 46 and communicated to the controller 40, so that the controller 40 responds to the pressing of the actuator 56 by causing the drive motor 36 to assume reverse operation, with causes the platen roller 30 to be rotated in the reverse direction B, which causes the latch 60 in the release direction R, similar to action described above.

The discussion above has generally assumed that the paper supply cavity 26 is associated with the base housing 24; however, in other embodiments, the paper supply cavity 26 (and thus the paper supply roll 5) may alternatively be associated with the cover 52. Likewise, the discussion above has assumed that the printhead 80 is associated with the cover 52 and the platen roller 30 is associated with the base housing 24; however, in some embodiments, this relationship may be inverted such that the printhead 80 is associated with the base housing 24 and the platen roller 30 is associated with the cover 52.

The discussion above has generally assumed that the cover 52 is pivotally mounted to the base housing 24; however, in other embodiments, the cover 52 may be additionally or alternatively slidingly mounted to the base housing 24. Further, it should be understood that the latch may take other forms than the latch frame 60 illustrated, such as a simplified swing-arm latch, or a mechanical detent latching mechanism, a magnetic coupling, or other types of latches known in the art. And, the latch 60 may be associated with either the base housing 24 or the cover 52, as is desired.

In some embodiments, the platen roller 30 may function as the latch 60, rather than having a latch 60 that is distinct from the platen roller 30. For example, for a detent latching mechanism embodiment, the printhead 80 may be slightly spring loaded and have a lip thereon that the platen roller 30 is normally disposed below when the printer 20 is printing. Reversing the drive motor 36 causes the platen roller 30 to rotate in the reverse direction B, and thereby “crawl” up the printhead 80. When the platen roller 30 rolls over the lip in printhead 80, the cover 52 is released so as to be able to be moved to the open position(s). Subsequently closing the cover 52 results in the platen roller 30 being forced back over the lip in printhead 80 so that the cover 52 is again latched to the base housing 24. For such an embodiment, the platen roller 30 and/or the printhead 80 may be viewed as being the “latch.”

The present invention may, of course, be carried out in other specific ways than those herein set forth without departing from the scope of the invention. The present embodiments are, therefore, to be considered as illustrative and not restrictive.

What is claimed is:

1. A printer, comprising:
a base housing;
a paper supply cavity;
a cover moveably mounted to the base housing for movement between a closed position where the cover helps enclose the paper supply cavity and at least one open position where the paper supply cavity is accessible;
a printhead movably associated with one of the base housing and the cover;
a platen roller rotatably mounted to the other of the base housing and the cover for rotation about a platen axis in a forward feed direction and a reverse direction;
a drive motor operatively coupled to the platen roller to drive the platen roller to rotate;
a latch movable between a latching position, where the latch connects the base housing to the cover such that the cover is latched in the closed position, and a release position where the latch is displaced relative to the latching position so as to allow movement of the cover toward the open position;
wherein, with the cover in the closed position:
the printhead and platen roller are positioned relatively closer to each other for printing on paper therebetween;
rotation of the platen roller in the reverse direction urges the latch toward the release position;
wherein, with the cover in the open position:
the printhead and platen roller are positioned relatively farther from each other so as to be positioned unsuitably for printing on paper therebetween.

2. The printer of claim 1, wherein the printhead is movably associated with the cover and the drive platen is associated with the base housing.

3. The printer of claim 1, wherein the cover is pivotally mounted to the base housing.

4. The printer of claim 1, wherein the base housing comprises the paper supply cavity.

5. The printer of claim 1, wherein, with the cover in the closed position, rotation of the platen roller in the forward feed direction urges the latch toward the latching position.

6. The printer of claim 1, wherein the latch comprises a latch frame pivotally mounted to the cover.

7. The printer of claim 1, wherein the cover is biased toward the open position.

8. The printer of claim 1, further comprising a processing circuit disposed within the base housing and operative to control rotation of the drive motor.

9. The printer of claim 8:
further comprising an externally accessible actuator that extends through the cover, the actuator in operative communication with the processing circuit;
wherein the processing circuit is configured to respond to actuation of the actuator by causing the drive motor to assume a reverse operation that drives the drive platen in the reverse direction, to thereby urge the latch toward the release position.

10. The printer of claim 1:
further comprising an externally accessible actuator that extends through the cover, the actuator in operative communication with the processing circuit;
wherein the actuator is normally disengaged from the latch, but disposed so that movement of the actuator mechanically engages the actuator to the latch and urges the latch toward the release position.

11. A method of controlling a printer, comprising:
rotating a drive motor in a forward direction, and, as a result:
driving a platen roller to rotate forwardly to latch a base housing of the printer to a cover of the printer such that the cover is latched in a closed position wherein the cover helps enclose a paper supply cavity of the printer;
thereafter, rotating the drive motor in a reverse direction, and, as a result:
driving the platen roller to rotate reversedly to automatically unlatch the cover from the base housing to thereby allow the cover to move to an open position.

12. The method of claim 11, wherein the rotating the drive motor in the reverse direction is in response to detection of a printer error by a controller local to the printer.

13. The method of claim 11, wherein the rotating the drive motor in the reverse direction is in response to receipt, by a controller local to the printer, of a command received from a controller remote from the printer.

14. The method of claim 11, wherein the driving the platen roller to rotate reversedly comprises driving the platen roller to rotate reversedly so as to move a latch, distinct from the platen roller, to an unlatching position to thereby allow the cover to move to an open position.

15. The method of claim 11, further comprising, after the rotating the drive motor in the reverse direction:
adding a paper supply to the paper supply cavity while the cover is not latched to the base assembly;
thereafter, moving the cover to the closed position and automatically latching the cover to the base housing.

16. A method of controlling a printer, comprising:
rotating a drive motor in a forward direction, and, as a result:
urging a latch toward a latching position by driving a platen roller to rotate forwardly; the latch, when in the latching position, connecting a base housing of the printer to a cover of the printer such that the cover is latched in a closed position wherein the cover helps enclose a paper supply cavity of the printer;
thereafter, rotating the drive motor in a reverse direction, and, as a result:
urging the latch toward a release position by driving the platen roller to rotate reversedly; the latch, in the release position, allowing the cover to move to an open position.

17. The method of claim 16, wherein the rotating the drive motor in the reverse direction is in response to detection of a printer error by a controller local to the printer.

18. The method of claim 16, wherein the rotating the drive motor in the reverse direction is in response to receipt, by a controller local to the printer, of a command received from a controller remote from the printer.

19. The method of claim 16, further comprising, after the rotating the drive motor in the reverse direction:
adding a paper supply to the paper supply cavity while the cover is not latched to the base assembly;
thereafter, moving the cover to the closed position and automatically latching the cover to the base housing via the latch.

20. The method of claim 16:
wherein the latch is biased toward the latching position;
wherein the urging the latch toward the release position comprises urging the latch toward the release position against a corresponding bias;
wherein the cover is biased toward the open position; wherein the allowing the cover to move to the open position comprises automatically moving the cover to the open position.
